(19) United States
(12) Patent Application Publication
(10) Pub. No.: US 2018/0375298 A1
(43) Pub. Date: Dec. 27, 2018

(54) SPARK PLUG

(71) Applicant: NGK SPARK PLUG CO., LTD., Nagoya-shi, Aichi (JP)

(72) Inventors: Kazuhiro KUROSAWA, Hashima-gun, Gifu (JP); Katsuya TAKAOKA, Ichinomiya-shi, Aichi (JP); Kuniharu TANAKA, Komaki-shi, Aichi (JP); Toshitaka HONDA, Nagoya-shi, Aichi (JP); Hirokazu KURONO, Nagoya-shi, Aichi (JP); Hironori UEGAKI, Nagoya-shi, Aichi (JP)

(73) Assignee: NGK SPARK PLUG CO., LTD., Nagoya-shi, Aichi (JP)

(21) Appl. No.: 16/064,772

(22) PCT Filed: Sep. 19, 2016
(86) PCT No.: PCT/JP2016/004262

§ 371 Date: Jun. 21, 2018

(30) Foreign Application Priority Data
Dec. 24, 2015 (JP) 2015-251395

(51) Int. Cl. H01T 13/05; F02P 13/00; H01T 13/39; H01T 13/41; H01T 21/02

(52) U.S. Cl. CPC H01T 13/05; F02P 13/00; H01T 21/02; H01T 13/41; H01T 13/39

(57) ABSTRACT

The present invention allows reduction in high frequency noise of a spark plug. A Fe-containing oxide layer is formed on the surface of a beneath-flange rod-shaped portion, of a metal terminal of the spark plug, between a terminal flange portion and an upper end of a metal shell. The surface area of the Fe-containing oxide layer is not less than 10% of the surface area of the beneath-flange rod-shaped portion.

### FIELD OF THE INVENTION

The present invention relates to a spark plug.

### BACKGROUND OF THE INVENTION

A spark plug used for an internal combustion engine generally includes: a tubular metal shell; a tubular insulator disposed in an inner hole of the metal shell; a center electrode inserted in an axial hole of the insulator so as to protrude from a front end of the insulator to the outside; a metal terminal inserted in the axial hole of the insulator so as to protrude from a rear end of the insulator to the outside; and a ground electrode having one end joined to the front side of the metal shell and having the other end opposed to the center electrode with a spark discharge gap interposed therebetween. The center electrode and the metal terminal are electrically connected to each other by a conductive seal portion provided in the axial hole of the insulator.

In recent years, as output of an internal combustion engine comes to be higher, it is required to increase spark discharge voltage of a spark plug. There is a concern that an increase in spark discharge voltage of a spark plug results in an increase in high frequency noise that occurs at the time of discharge, and an electronic control device of a vehicle is adversely affected. Therefore, it has been desired to reduce the high frequency noise of the spark plug.

Conventionally, various techniques have been proposed in order to reduce high frequency noise that occurs at the time of discharge performed by the spark plug. For example, in Japanese Patent Application Laid-Open (kokai) No. 2004-259605, a configuration is proposed in which a noise-suppressing resistor is provided at a position, in an axial hole of an insulator, above an upper end of a metal shell.

However, in the above-described conventional technique, there is a problem that the insulator has a high risk of being damaged by vibrations of the resistor, and impact resistance and airtightness are difficult to be ensured. Therefore, a technique for reducing high frequency noise of a spark plug by means that is different from the conventional means, has been desired.

### SUMMARY OF THE INVENTION

The present invention has been conceived of in order to address the above-described problem, and can be embodied in the following modes.

(1) According to a first aspect of the present invention, there is provided a spark plug which includes: an insulator having an axial hole extending in a direction of an axis; a center electrode inserted in the axial hole so as to protrude from a front end of the insulator to an outside; a metal terminal inserted in the axial hole so as to protrude from a rear end of the insulator to the outside; a conductive seal portion disposed in the axial hole so as to electrically connect the center electrode and the metal terminal to each other; and a metal shell accommodating the insulator. The metal terminal has a terminal flange portion which is in contact with the rear end of the insulator. In the spark plug, a Fe-containing oxide layer is formed on a surface of a beneath-flange rod-shaped portion, of the metal terminal, between the terminal flange portion and a rear end of the metal shell, and a surface area of the Fe-containing oxide layer is not less than 10% of a surface area of the beneath-flange rod-shaped portion. In a portion, of a generally used spark plug, on the rear side relative to the rear end of the metal shell (i.e., a portion above an upper end of the metal shell), no high frequency current flows via the insulator, and thus, noise reduction effect of a Fe-containing oxide is likely to be obtained. According to the above-described spark plug, since the Fe-containing oxide layer is provided on the surface of the beneath-flange rod-shaped portion between the terminal flange portion and the rear end of the metal shell so as to coat not less than 10% of the surface area of the beneath-flange rod-shaped portion, sufficiently high noise reduction effect can be obtained.

(2) In accordance with a second aspect of the present invention, there is provided a spark plug as described above, wherein a plating layer is formed from one or more metals selected from among Ni, Cu, Cr, Zn, and Fe may be formed on the surface of the beneath-flange rod-shaped portion, and the Fe-containing oxide layer may be formed on the plating layer. By coating the surface of the beneath-flange rod-shaped portion with the plating layer, when the conductive seal portion is subjected to heat treatment, a reactional phase is formed between the plating layer and the Fe-containing oxide layer, whereby adhesion therebetween becomes satisfactory. As a result, the Fe-containing oxide layer is less likely to peel off from the beneath-flange rod-shaped portion, whereby the noise reduction effect of the Fe-containing oxide layer can be further improved.

(3) In accordance with a third aspect of the present invention, there is provided a spark plug as described above, wherein an average thickness of the Fe-containing oxide layer is not smaller than 10 μm and is not larger than 200 μm. If the average thickness of the Fe-containing oxide layer is smaller than 10 μm, the noise attenuation effect tends to be reduced to some extent. In addition, if the average thickness is larger than 200 μm, there is a possibility that the Fe-containing oxide layer peels off owing to the difference in thermal expansion coefficient between the beneath-flange rod-shaped portion and the Fe-containing oxide layer, and the noise reduction effect is reduced.

(4) In accordance with a fourth aspect of the present invention, there is provided a spark plug as described above, wherein the surface area of the Fe-containing oxide layer is not less than 50% of the surface area of the beneath-flange rod-shaped portion. The larger the surface area of the Fe-containing oxide layer is, the higher the noise reduction effect becomes. By setting the surface area of the Fe-containing oxide layer to be not less than 50% of the surface area of the beneath-flange rod-shaped portion, the highest noise reduction effect can be obtained.

(5) In accordance with a fifth aspect of the present invention, there is provided a spark plug as described above, wherein the conductive seal portion has a magnetic composite phase formed from a Fe-containing oxide, conductive particles, and a glass component. By providing such a magnetic composite phase to the conductive seal portion, the noise reduction effect can be further improved.

The present invention can be embodied in various modes such as modes of a spark plug and a spark plug manufacturing method.

### BRIEF DESCRIPTION OF THE DRAWINGS

FIG. 1 is a cross-sectional view showing the entire configuration of a spark plug according to a first embodiment of the present invention.

FIGS. 2A, 2B, and 2C are explanatory views showing a configuration of a metal terminal according to the first embodiment.

FIG. 3 is a flowchart showing a surface area measurement method.

FIGS. 4A, 4B, and 4C are explanatory views showing a configuration of a metal terminal according to a second embodiment.

FIGS. 5A, 5B, and 5C are explanatory views showing a configuration of a metal terminal according to a third embodiment.

FIG. 6 is a diagram showing noise attenuation test results for various samples.

### DETAILED DESCRIPTION OF THE INVENTION

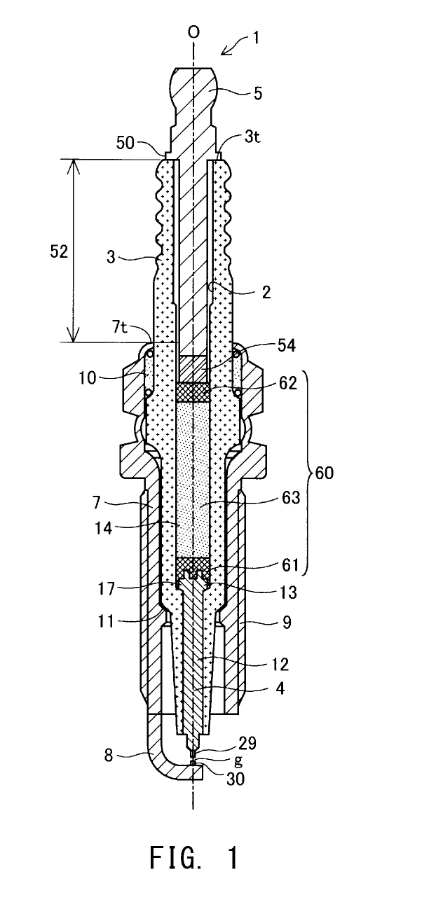

FIG. 1 is a cross-sectional view showing the entire configuration of a spark plug 1 according to a first embodiment of the present invention. The lower side (firing end side) in FIG. 1 is referred to as a front side of the spark plug 1, and the upper side (terminal side) is referred to as a rear side. The spark plug 1 includes: an insulator 3 having an axial hole 2 extending in a direction of an axis O; a center electrode 4 inserted in the axial hole 2 so as to protrude from a front end of the insulator 3 to the outside; a metal terminal 5 inserted in the axial hole 2 so as to protrude from a rear end 3t of the insulator 3; a conductive seal portion 60 disposed in the axial hole 2 so as to electrically connect the center electrode 4 and the metal terminal 5 to each other; a metal shell 7 accommodating the insulator 3; and a ground electrode 8 disposed such that one end thereof is joined to a front end surface of the metal shell 7 and the other end is opposed to the center electrode 4 with a gap interposed therebetween.

The metal shell 7 has a substantially cylindrical shape, and is formed so as to accommodate and hold the insulator 3. A screw portion 9 is formed on an outer circumferential surface, in the frontward direction, of the metal shell 7. With use of the screw portion 9, the spark plug 1 is mounted to a cylinder head of an internal combustion engine that is not shown.

The insulator 3 is held by an inner circumference portion of the metal shell 7 via a talc 10 and a packing 11. The axial hole 2 of the insulator 3 includes: a small-diameter portion 12 holding the center electrode 4 on the front side of the axis O; and an intermediate-diameter portion 14 accommodating the conductive seal portion 60 and having a larger inner diameter than the small-diameter portion 12. The axial hole 2 further includes, between the small-diameter portion 12 and the intermediate-diameter portion 14, a tapered first stepped portion 13 having a diameter increasing toward the rear side. The insulator 3 is fixed to the metal shell 7 in a state where the front end thereof protrudes from the front end surface of the metal shell 7. It is desirable that the insulator 3 is formed from a material having mechanical strength, thermal strength, electrical strength, and the like. Examples of such a material include a ceramic sintered body containing alumina as a main ingredient.

The center electrode 4 is accommodated in the small-diameter portion 12 of the insulator 3, and is held so as to be insulated from the metal shell 7 in a state where a flange portion 17 provided at a rear end of the center electrode 4 and having a large diameter is locked by the first stepped portion 13 of the insulator 3 and where a front end of the center electrode 4 protrudes from a front end surface of the insulator 3. It is desirable that the center electrode 4 is formed from a material having thermal conductivity, mechanical strength, and the like. The center electrode 4 is formed from, for example, a Ni-based alloy such as INCONEL (trademark). An axial portion of the center electrode 4 may be formed from a metal material, such as Cu or Ag, that has excellent thermal conductivity.

The ground electrode 8 is formed such that: one end thereof is joined to the front end surface of the metal shell 7; an intermediate portion thereof is bent to be substantially L-shaped; and the other end is opposed to the front end of the center electrode 4 with a gap interposed therebetween. The ground electrode 8 is formed from a material similar to the material from which the center electrode 4 is formed.

Noble metal tips 29, 30 formed from a platinum alloy, an iridium alloy, or the like are provided at portions, which are opposed to each other, of the center electrode 4 and the ground electrode 8. A spark discharge gap g is formed between the noble metal tips 29, 30. Either or both of the noble metal tips of the center electrode 4 and the ground electrode 8 may be omitted.

The metal terminal 5 is a terminal for externally applying, to the center electrode 4, a voltage for causing spark discharge between the center electrode 4 and the ground electrode 8. An uneven portion 54 of which the outer circumferential surface is unevenly shaped by knurling or the like is preferably provided on the front side of the metal terminal 5. By providing such an uneven portion 54, adhesion between the metal terminal 5 and the conductive seal portion 60 becomes satisfactory, and the metal terminal 5 and the insulator 3 are firmly fixed to each other. A terminal flange portion 50 is provided on the rear side of the metal terminal 5 so as to be in contact with the rear end 3t of the insulator 3. The metal terminal 5 is formed from a metal material such as low-carbon steel.

A portion, of the metal terminal 5, between the terminal flange portion 50 and a rear end 7t of the metal shell 7 is referred to as “beneath-flange rod-shaped portion 52”. A Fe-containing oxide layer described below is formed on the surface of the beneath-flange rod-shaped portion 52. As an underlayer for the Fe-containing oxide layer, a plating layer formed from one or more metals selected from among Ni, Cu, Cr, Zn, and Fe is preferably formed. These features will be further described below.

The conductive seal portion 60 is disposed between the center electrode 4 and the metal terminal 5 in the axial hole 2 so as to electrically connect the center electrode 4 and the metal terminal 5 with each other. The conductive seal portion 60 has a magnetic composite phase 63 formed from a Fe-containing oxide, conductive particles, and a glass component, has a first seal phase 61 between the magnetic composite phase 63 and the center electrode 4, and has a second seal phase 62 between the magnetic composite phase 63 and the metal terminal 5. The first seal phase 61 and the second seal phase 62 fix the insulator 3 and the center electrode 4 to each other, and the insulator 3 and the metal terminal 5 to each other, respectively, in a sealed state. The first seal phase 61 and the second seal phase 62 can be each formed by sintering a seal powder that contains glass powder of borosilicate soda glass or the like and metal powder of Cu, Fe, or the like.

As the Fe-containing oxide of the magnetic composite phase 63, an iron oxide (FeO, Fe₂O₃, Fe₃O₄, or the like) or various kinds of ferrite may be used, for example. As the conductive particles of the magnetic composite phase 63, Ni powder, C powder, or the like may be used, for example. By providing such a magnetic composite phase 63 to the conductive seal portion 60, the noise reduction effect can be further improved. However, the magnetic composite phase 63 may be omitted.

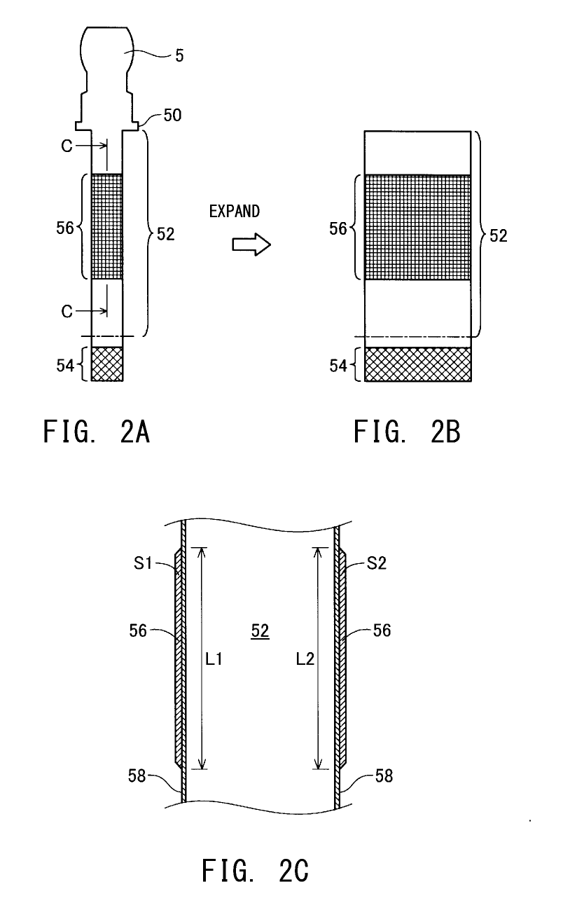

FIG. 2A is an explanatory view showing a configuration of the metal terminal 5 according to the first embodiment. The Fe-containing oxide layer 56 having noise reduction effect is formed on the surface of the beneath-flange rod-shaped portion 52. As described above, the beneath-flange rod-shaped portion 52 is a portion between the terminal flange portion 50 and the rear end 7t (FIG. 1) of the metal shell 7. In the example in FIG. 2A, the uneven portion 54 on the front side of the metal terminal 5 is not included in the beneath-flange rod-shaped portion 52. However, in a case where a part of the uneven portion 54 is located above the rear end 7t of the metal shell 7, the part is also included in the beneath-flange rod-shaped portion 52.

As the Fe-containing oxide forming the Fe-containing oxide layer 56, one or more of the following Fe-containing oxides may be used.

Iron oxide: FeO, Fe₂O₃, Fe₃O₄; spinel ferrite: (Ni, Zn) Fe₂O₄, Ni₂Fe₂O₄, (Mn, Zn) Fe₂O₄, CuFe₂O₄, NiFe₂O₄; hexagonal crystal ferrite: BaFe₁₂O₁₉, SrFe₁₂O₁₉, Ba₂Mg₂Fe₁₂O₂₂, Ba₂Ni₂Fe₁₂O₂₂, Ba₂CO₂Fe₁₂O₂₂; and garnet ferrite: YFe₅O₁₂

FIG. 2B is an expanded view of a portion, of the metal terminal 5, below the terminal flange portion 50. In this example, the Fe-containing oxide layer 56 has a fixed width (a dimension of the Fe-containing oxide layer 56 measured along the up-down direction of the spark plug 1), and is formed over the entire circumference of the rod-shaped portion.

The surface area of the Fe-containing oxide layer 56 is preferably not less than 10% of the surface area of the beneath-flange rod-shaped portion 52. In a portion, of the spark plug 1, that is closer to the terminal flange portion 50 than the rear end 7t of the metal shell 7, no high frequency current flows via the insulator 3, and thus, the noise reduction effect of the Fe-containing oxide is likely to be obtained. By providing the Fe-containing oxide layer 56 on the surface of the beneath-flange rod-shaped portion 52 so as to coat not less than 10% of the surface area thereof, sufficiently high noise reduction effect can be obtained. In addition, since the Fe-containing oxide layer 56 is a thin layer that is adhered to the surface of the beneath-flange rod-shaped portion 52, the Fe-containing oxide layer 56 is unlikely to peel off by vibrations of the spark plug 1, and a problem regarding impact resistance and airtightness hardly arises. The surface area of the Fe-containing oxide layer 56 is further preferably not less than 50% of the surface area of the beneath-flange rod-shaped portion 52. The larger the surface area of the Fe-containing oxide layer 56 is, the higher the noise reduction effect becomes. By setting the surface area of the Fe-containing oxide layer 56 to be not less than 50% of the surface area of the beneath-flange rod-shaped portion 52, the highest noise reduction effect can be obtained.

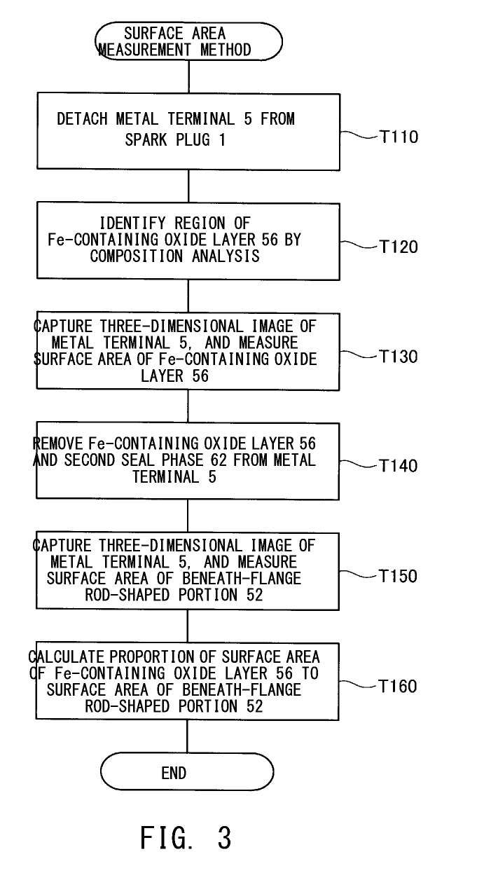

FIG. 3 is a flowchart showing a measurement method for the surface area of the Fe-containing oxide layer 56 and the surface area of the beneath-flange rod-shaped portion 52. In step T110, the metal terminal 5 is detached from the spark plug 1. Specifically, for example, after the metal shell 7 is detached, the insulator 3 is whittled down from radially outward thereby to reduce the thickness of the insulator 3, and thereafter, the insulator 3 is broken, and the metal terminal 5 is detached from the insulator 3. The purpose of reducing the thickness of the insulator 3 before the breakage thereof is to prevent the Fe-containing oxide layer 56 from peeling off from the metal terminal 5 by an impact at the time of the breakage. Therefore, it is preferable to reduce the thickness of the insulator 3 before the breakage thereof, and break the insulator 3 with as small a force as possible.

In step T120, a region of the Fe-containing oxide layer 56 is identified with use of a composition analysis. For the composition analysis, an X-ray photoelectron spectroscopic device (XPS) may be used, for example.

In step T130, a three-dimensional image of the metal terminal 5 is captured with use of a three-dimensional scanner, and the surface area of the Fe-containing oxide layer 56 is measured from the three-dimensional image. This surface area is a surface area in a state of being expanded as in FIG. 2B.

In step T140, the Fe-containing oxide layer 56 and the second seal phase 62 (if adhered) are removed from the metal terminal 5. The reason why these components are removed is because the surface area of the beneath-flange rod-shaped portion 52 cannot be accurately measured in a state where the Fe-containing oxide layer 56 and the second seal phase 62 are adhered to the surface of the beneath-flange rod-shaped portion 52.

In step T150, a three-dimensional image of the resultant metal terminal 5 is captured again with use of the three-dimensional scanner, and the surface area of the beneath-flange rod-shaped portion 52 is measured from the three-dimensional image. In a case where a part of the uneven portion 54 is included in the beneath-flange rod-shaped portion 52, the surface area of the beneath-flange rod-shaped portion 52 is calculated while portions corresponding to grooves and roots in the uneven portion 54 are ignored. Specifically, the surface area is calculated on the premise that the uneven portion 54 has a columnar shape of which the outer shape is a portion corresponding to a projection (crest) thereof.

In step T160, the proportion of the surface area of the Fe-containing oxide layer 56 to the surface area of the beneath-flange rod-shaped portion 52 is calculated.

By obtaining the surface areas of the beneath-flange rod-shaped portion 52 and the Fe-containing oxide layer 56 with use of the three-dimensional images, the surface areas can be measured with high accuracy even if the beneath-flange rod-shaped portion 52 is bent to some extent.

FIG. 2C shows a C-C cross section of the beneath-flange rod-shaped portion 52 in FIG. 2A. In this example, a plating layer 58 formed from one or more metals selected from among Ni, Cu, Cr, Zn, and Fe is formed on the surface of the beneath-flange rod-shaped portion 52. The Fe-containing oxide layer 56 is formed on the plating layer 58. Since the surface of the beneath-flange rod-shaped portion 52 is coated with the plating layer 58, when the conductive seal portion 60 is subjected to heat treatment, a reactional phase is formed between the plating layer 58 and the Fe-containing oxide layer 56, whereby adhesion therebetween becomes satisfactory. In a process of heating the conductive seal portion 60, the metal terminal 5 is inserted in the axial hole 2 of the insulator 3, and, while a material with which the axial hole 2 is filled is pressed by the metal terminal 5 toward the front side, the entire insulator 3 is heated to a predetermined temperature of 700 to 950° C. in a state of being placed in a heating furnace. By providing the plating layer 58 as an underlayer for the Fe-containing oxide layer 56, the Fe-containing oxide layer 56 becomes less likely to peel off from the beneath-flange rod-shaped portion 52, and thus, the impact resistance can be improved, whereby the noise reduction effect of the Fe-containing oxide layer 56 can be further improved. The plating layer 58 may be provided only at, instead of the entire surface of the beneath-flange rod-shaped portion 52, a part thereof that includes a portion on which the Fe-containing oxide layer 56 is formed. In addition, the plating layer 58 may be omitted.

The average thickness of the Fe-containing oxide layer 56 is preferably not smaller than 10 μm and not larger than 200 μm. If the average thickness of the Fe-containing oxide layer 56 is smaller than 10 μm, there is a possibility that the noise attenuation effect is not sufficiently obtained. If the average thickness is larger than 200 μm, there is a possibility that the Fe-containing oxide layer 56 peels off owing to the difference in thermal expansion coefficient between the Fe-containing oxide layer 56 and the beneath-flange rod-shaped portion 52, and the noise reduction effect is reduced.

The average thickness of the Fe-containing oxide layer 56 is measured by the following method. First, in a vertical cross section (FIG. 2C) obtained by abrading the beneath-flange rod-shaped portion 52 to the center thereof, a total value (S1+S2) of areas S1, S2 of the Fe-containing oxide layer 56 is obtained, and a total value (L1+L2) of lengths L1, L2 of the interfaces between the Fe-containing oxide layer 56 and the plating layer 58 is obtained. Then, the total value (S1+S2) of the areas is divided by the total value (L1+L2) of the boundary lengths, thereby obtaining the average thickness of the Fe-containing oxide layer 56. In the example in FIG. 2C, the Fe-containing oxide layer 56 is illustrated as if having a substantially fixed thickness, but in fact, the thickness of the Fe-containing oxide layer 56 varies to a great extent, and an uneven cross section is observed. However, as described above, since the beneath-flange rod-shaped portion 52 is abraded to the center thereof, and the total value of the areas of the Fe-containing oxide layer 56 and the total value of the boundary lengths are obtained, a highly accurate value can be obtained as an average thickness.

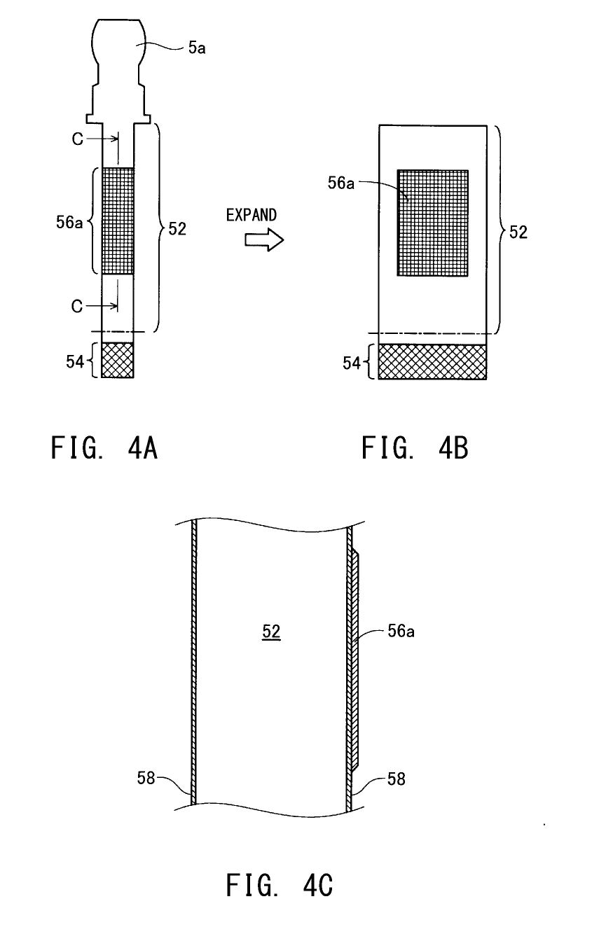

FIGS. 4A, 4B, and 4C are explanatory views showing a configuration of a metal terminal 5a of a spark plug according to a second embodiment of the present invention. As shown in FIG. 4B and FIG. 4C, the metal terminal 5a is different from the metal terminal according to the first embodiment in that a Fe-containing oxide layer 56a is not formed over the entire circumference of the beneath-flange rod-shaped portion 52, but is formed only at a part of the entire circumference of the beneath-flange rod-shaped portion 52. The other configurations are the same as those in the first embodiment. The surface areas and the average thickness of the Fe-containing oxide layer 56a are preferably set to be within ranges similar to those in the first embodiment. Also in the second embodiment, effects similar to those in the first embodiment are exhibited.

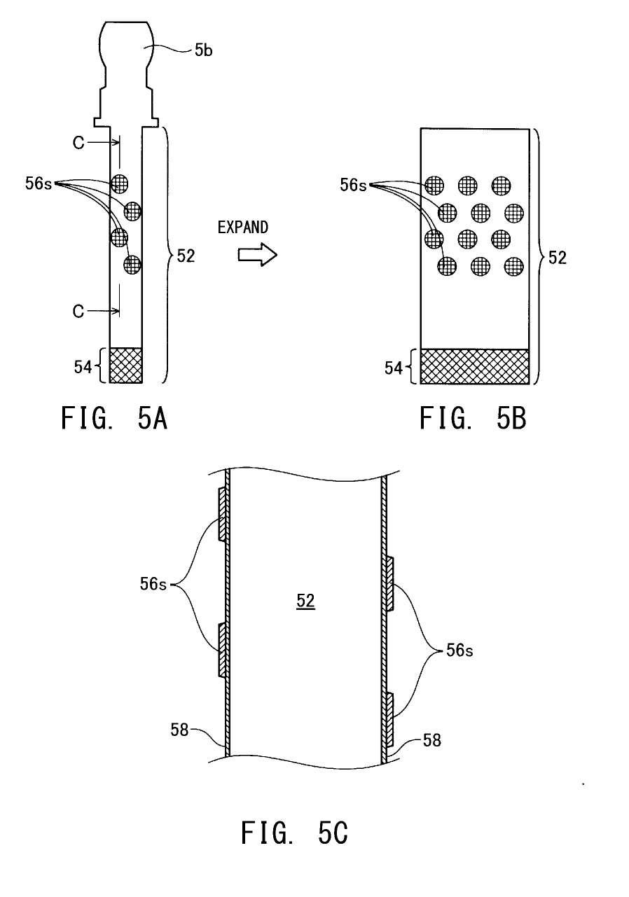

FIGS. 5A, 5B, and 5C are explanatory views showing a configuration of a metal terminal 5b of a spark plug according to a third embodiment of the present invention. As shown in FIG. 5B and FIG. 5C, the metal terminal 5b is different from the metal terminal according to the first embodiment in that a plurality of Fe-containing oxide layers 56s are formed on the beneath-flange rod-shaped portion 52 so as to be scattered in an island pattern. The other configurations are the same as those in the first embodiment. The total surface area and the average thickness of the plurality of Fe-containing oxide layers 56s are preferably set to be within ranges similar to those in the first embodiment. Also in the third embodiment, effects similar to those in the first embodiment are exhibited.

### EXAMPLES

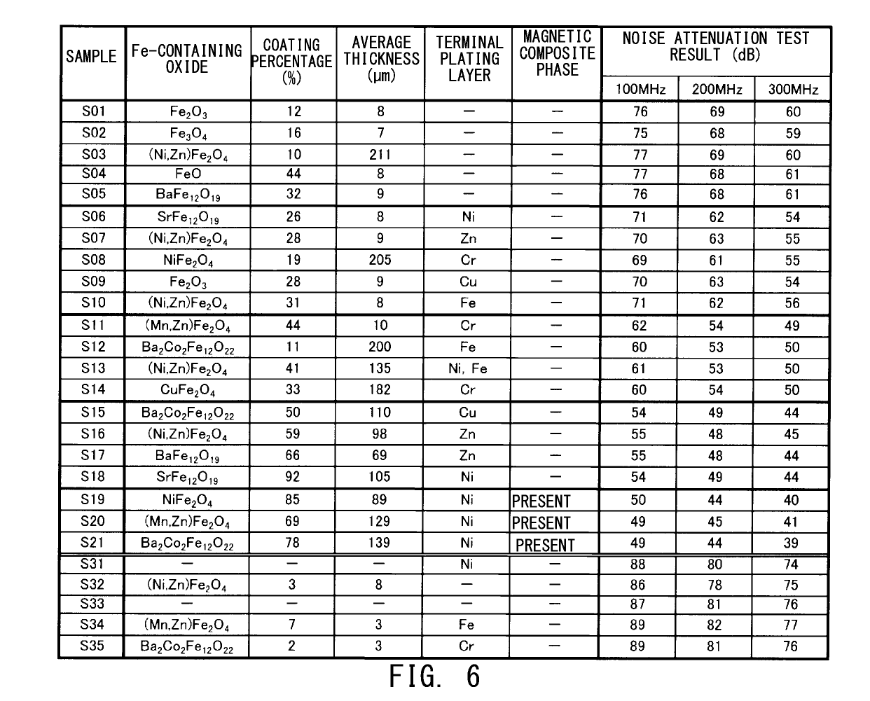

FIG. 6 is a diagram showing features of the Fe-containing oxide layers 56 and noise attenuation test results, for various samples. Samples S01 to S21 are spark plug samples as examples, and samples S31 to S35 are spark plug samples as comparative examples. Regarding each Fe-containing oxide layer 56, a composition of a Fe-containing oxide, a coating percentage thereof, an average thickness thereof, a composition of a plating layer as an underlayer, and presence/absence of the magnetic composite phase 63, are shown. The coating percentage is a proportion of the surface area of the Fe-containing oxide layer 56 to the surface area of the beneath-flange rod-shaped portion 52. The plating layer 58 used in each of samples S06 to S21, S31, S34, and S35 was formed on the entire surface of the metal terminal 5. As the magnetic composite phase 63 in each of samples S19 to S21, a mixture of NiZn ferrite, Ni powder, and a glass component was used.

On the right side of FIG. 6, the results of noise attenuation tests for the respective samples are shown. The noise attenuation tests were performed in accordance with the “Automobile-Radio Noise Characteristics-Second Part: Measurement Method for Prevention Device, and Current Method” of JASO D-002-2 (transmission standards set by the Japanese Automotive Standards Organization D-002-2). As measurement target high frequency noise, noise at three types of frequencies, i.e., 100 MHz, 200 MHz, and 300 MHz was measured.

From the test results shown in FIG. 6, the following points can be understood.

(1) In each of samples S01 to S21 of the examples, the coating percentage of the surface, of the beneath-flange rod-shaped portion 52, coated with the Fe-containing oxide layer 56 is not lower than 10%. More specifically, the coating percentages in samples S01 to S21 are within a range of not lower than 10% and not higher than 92%. Meanwhile, in each of samples S31 to S35 of the comparative examples, the coating percentage is lower than 10%. In each of samples S01 to S21 of the examples, as compared with samples S31 to S35 of the comparative examples, noise at any of the frequencies is small, and satisfactory noise reduction effect is obtained.

(2) Each of samples S06 to S21 is different from samples S01 to S05 in that the plating layer 58 formed from metal such as Ni, Cu, Cr, Zn, and/or Fe was formed on the surface of the beneath-flange rod-shaped portion 52, and the Fe-containing oxide layer 56 was formed on the plating layer 58. These samples S06 to S21 are preferable in that the noise reduction effect is higher to some extent than in samples S01 to S05 including no plating layer 58. However, it is assumed that a major effect of the plating layer 58 is that the Fe-containing oxide layer 56 and the plating layer 58 are firmly adhered to each other so that the Fe-containing oxide layer 56 is less likely to peel off. It is highly probable that also the increase in the noise reduction effect obtained in FIG. 6 is attributed to the effect that the Fe-containing oxide layer 56 is less likely to peel off.

(3) Each of samples S11 to S21 is different from samples S01 to S10 in that the average thickness of the Fe-containing oxide layer 56 is not smaller than 10 μm and not larger than 200 μm. These samples S11 to S21 are preferable in that the noise reduction effect is further higher than in samples S01 to S10 in each of which the average thickness of the Fe-containing oxide layer 56 is not within this range. If the average thickness of the Fe-containing oxide layer 56 is smaller than 10 μm, the noise attenuation effect tends to be reduced to some extent. It is assumed that the reason why the noise reduction effect is low in samples S03 and S08 in each of which the average thickness of the Fe-containing oxide layer 56 is larger than 200 μm is because a part of the Fe-containing oxide layer 56 peeled off owing to the difference in thermal expansion coefficient between the beneath-flange rod-shaped portion 52 and the Fe-containing oxide layer 56, and the noise reduction effect was reduced.

(4) Each of samples S15 to S21 is different from samples S01 to S14 in that the coating percentage of the surface, of the beneath-flange rod-shaped portion 52, coated with the Fe-containing oxide layer 56 is not lower than 50%. These samples S15 to S21 are preferable in that the noise reduction effect is further higher than in samples S01 to S14 in each of which the coating percentage is lower than 50%. No significant improvement in the noise reduction effect is observed after the coating percentage exceeds 50%. Therefore, the coating percentage is further preferably not lower than 50% and not higher than 60%.

(5) Each of samples S19 to S21 is different from samples S01 to S18 in that the conductive seal portion 60 includes the magnetic composite phase 63. These samples S19 to S21 are preferable in that the noise reduction effect is further higher than in samples S01 to S18 including no magnetic composite phase 63.

### Modification

The present invention is not limited to the above-described embodiments and modes, but may be embodied in various other forms without departing from the scope of the invention.

### Modification 1

As the spark plug, spark plugs having various configurations other than that shown in FIG. 1 may be applied to the present invention.

### DESCRIPTION OF REFERENCE NUMERALS

1: spark plug
2: axial hole
3: insulator
3t: rear end of insulator
4: center electrode
5: metal terminal
7: metal shell
7t: rear end of metal shell
8: ground electrode
9: screw portion
10: talc
11: packing
12: small-diameter portion
13: first stepped portion
14: intermediate-diameter portion
17: flange portion
29: noble metal tip
30: noble metal tip
50: terminal flange portion
52: beneath-flange rod-shaped portion
54: uneven portion
58: plating layer
60: conductive seal portion
61: first seal phase
62: second seal phase
63: magnetic composite phase

1. A spark plug comprising:
an insulator having an axial hole extending in a direction of an axis;
a center electrode inserted in the axial hole so as to protrude from a front end of the insulator to an outside;
a metal terminal inserted in the axial hole so as to protrude from a rear end of the insulator to the outside;
a conductive seal portion disposed in the axial hole so as to electrically connect the center electrode and the metal terminal to each other; and
a metal shell accommodating the insulator, wherein
the metal terminal has a terminal flange portion which is in contact with the rear end of the insulator,
a Fe-containing oxide layer is formed on a surface of a beneath-flange rod-shaped portion, of the metal terminal, between the terminal flange portion and an upper end of the metal shell, and
a surface area of the Fe-containing oxide layer is not less than 10% of a surface area of the beneath-flange rod-shaped portion.

2. The spark plug according to claim 1, wherein
a plating layer formed from one or more metals selected from among Ni, Cu, Cr, Zn, and Fe is formed on the surface of the beneath-flange rod-shaped portion, and
the Fe-containing oxide layer is formed on the plating layer.

3. The spark plug according to claim 1, wherein an average thickness of the Fe-containing oxide layer is not smaller than 10 μm and not larger than 200 μm.

4. The spark plug according to claim 1, wherein the surface area of the Fe-containing oxide layer is not less than 50% of the surface area of the beneath-flange rod-shaped portion.

5. The spark plug according to claim 1, wherein the conductive seal portion has a magnetic composite phase formed from a Fe-containing oxide, conductive particles, and a glass component.
